(19) United States
(12) Patent Application Publication
(10) Pub. No.: US 2017/0241864 A1
(43) Pub. Date: Aug. 24, 2017

(54) LENS DETECTION DEVICES AND DETECTION SYSTEMS

(71) Applicant: Shenzhen Hali-Power Industrial Co., Ltd., Shenzhen (CN)

(72) Inventor: Xiaomin ZHU, Shenzhen (CN)

(21) Appl. No.: 15/494,527

(22) Filed: Apr. 23, 2017

Related U.S. Application Data
(63) Continuation-in-part of application No. 15/014,041, filed on Feb. 3, 2016.
Application No. 15/014,041 is a continuation-in-part of application No. 15/013,943, filed on Feb. 2, 2016, now abandoned.
Application No. 15/013,943 is a continuation-in-part of application No. 15/159,768, filed on May 19, 2016.

(51) Int. Cl. G01M 11/02; G01J 1/42

(52) U.S. Cl. CPC G01M 11/0285; G01J 1/429; G01M 11/0207

(57) ABSTRACT

The present disclosure relates to a lens detection device and a lens detection system, wherein the lens detection device, including: a housing; and a detection module configured within the housing; wherein the detection module includes a control module, at least one light emitting module, and a photosensitive module cooperating with the light emitting module; the control module controls the light emitting module and the photosensitive module for conducting a detection process to a lens disposed between the light emitting module and the photosensitive module. As such, the lens detection may become much more convenient, the detection time may be reduced, and the lens detection device may be adopted widely thereby.

### CROSS REFERENCE TO RELATED APPLICATION

This application is a continuation in part and claims benefit of the following patent properties: (1) U.S. patent application Ser. No. 15/014,041, entitled “SKIN MOISTURE TESTING SYSTEM AND METHOD” filed on Feb. 3, 2016, (2) U.S. patent application Ser. No. 15/013,943, entitled “ULTRAVIOLET DETECTION SYSTEM AND METHOD” filed on Feb. 2, 2016, and (3) U.S. patent application Ser. No. 15/159,768, entitled “SKIN MOISTURE TESTING SYSTEM AND METHOD” filed on May 19, 2016. The above listed applications are hereby incorporated by reference herein as if set forth in its entirety.

### BACKGROUND

1. Technical Field

The present disclosure generally relates to lens detection field, particularly relates to a lens detection device and a detection system.

2. Description of Related Art

With the development of the vision care and the evolution of the social technology, culture, and living standard, glasses have play an important role in our daily life. Glasses may correct a variety of vision problems including myopia, hyperopia, astigmatism, presbyopia and strabismus. Other types of glasses, including goggles, sunglasses, swimming goggles, may provide a variety of protection for the eyes.

Glasses are simple optical components made of lens and frame and are configured to correct vision and protect eyes. Lens plays an important role in vision correction and eyes protection. Conventionally, the detection and the analysis with respect to glasses are conducted by manpower, and the lens detection is inconvenient due to complex detection processes, inaccurate detection results, and time-consuming of the detection.

### SUMMARY

The disclosure relates to a lens detection device.

In one aspect, the lens detection device, including: a housing; and a detection module configured within the housing; wherein the detection module includes a control module, at least one light emitting module, and a photosensitive module cooperating with the light emitting module; the control module controls the light emitting module and the photosensitive module for conducting a detection process to a lens disposed between the light emitting module and the photosensitive module.

In another aspect, the present disclosure further relates to a lens detection system, including: an emitting unit configured to emit detection light beams, a detection unit configured to receive the detection light beams, a control unit configured to receive and to process data of the emitting unit and the detection unit.

In another aspect, the present disclosure further relates to a lens detection method, including: obtaining photosensitive data via at least one lens; conducting a data processing process on the photosensitive data via a predetermined algorithm to obtain processing result; displaying the processing result; wherein the photosensitive data includes at least one light wavelength, light intensity, and lens refractive index.

Wherein the displaying process includes: transforming the processing result into electrical signals; controlling at least one indicator lamp having a corresponding color via the electrical signals.

As such, the lens detection may become much more convenient, the detection time may be reduced, and the lens detection device may be adopted widely thereby. The lens is disposed between the light emitting module and the photosensitive module, and the light emitting module emits light beams to the photosensitive module via the lens. The photosensitive module collects wavelength of the light beams, intensity of the light beams, and refractive index of the lens. The control module processes data rapidly and displays a detection result of the lens.

Such that, the detection result may be displayed intuitively. It is only necessary to place the lens to be detected to a designated position of the detection device, and the detection device may obtain the detection result quickly and easily, so that the lens detection may become much simpler and more convenient.

The present disclosure may conduct an effective detection process via the detection module, the light emitting module, and the photosensitive module cooperate with the light emitting module.

### BRIEF DESCRIPTION OF THE DRAWINGS

FIG. 1 is a schematic view of a detection device in accordance with one embodiment of the present disclosure.

FIG. 2 is a schematic view of the detection device in accordance with one embodiment of the present disclosure.

FIG. 3 is an explosion diagram of the detection device in accordance with one embodiment of the present disclosure.

FIG. 4 is a schematic view of a detection system in accordance with one embodiment of the present disclosure.

FIG. 5 is a schematic diagram showing a circuit structure of the detection system in accordance with one embodiment of the present disclosure.

FIG. 6 is a schematic diagram showing a circuit structure of an indicator lamp in accordance with one embodiment of the present disclosure.

FIG. 7 is a flowchart of a detection method in accordance with one embodiment of the present disclosure.

FIG. 8 is a flowchart of a detection method in accordance with one embodiment of the present disclosure.

### DETAILED DESCRIPTION

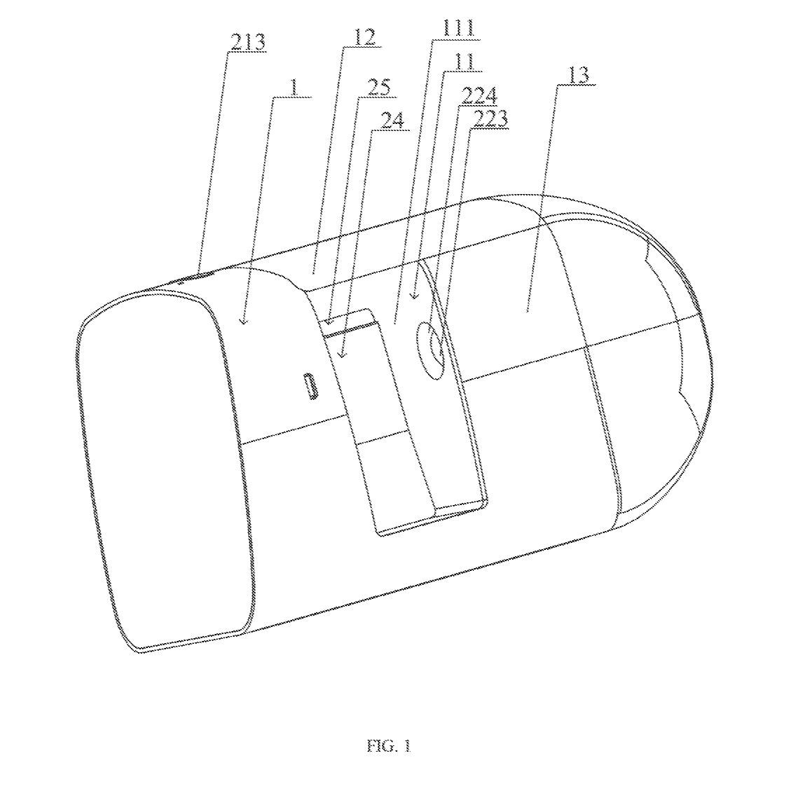

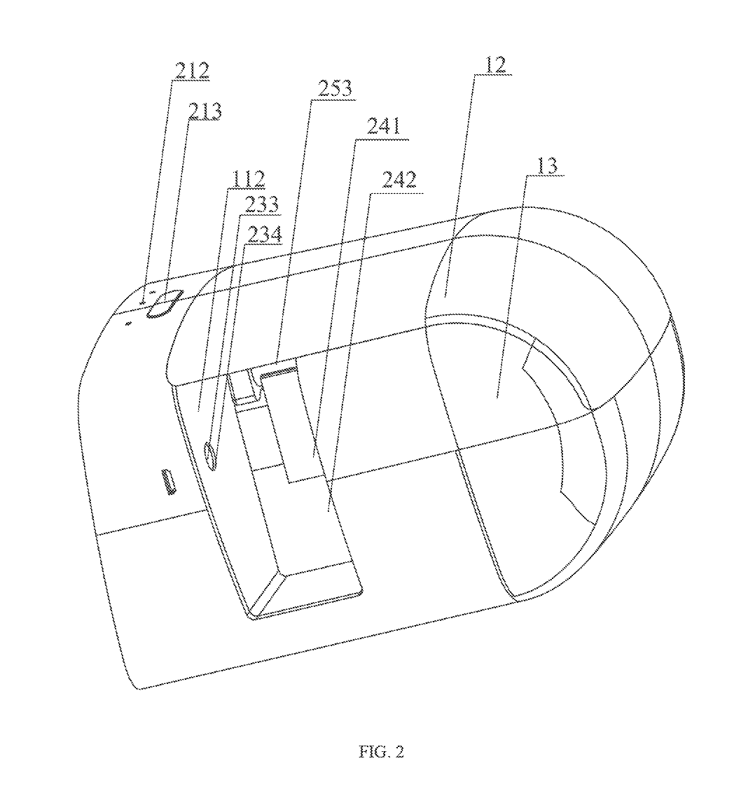

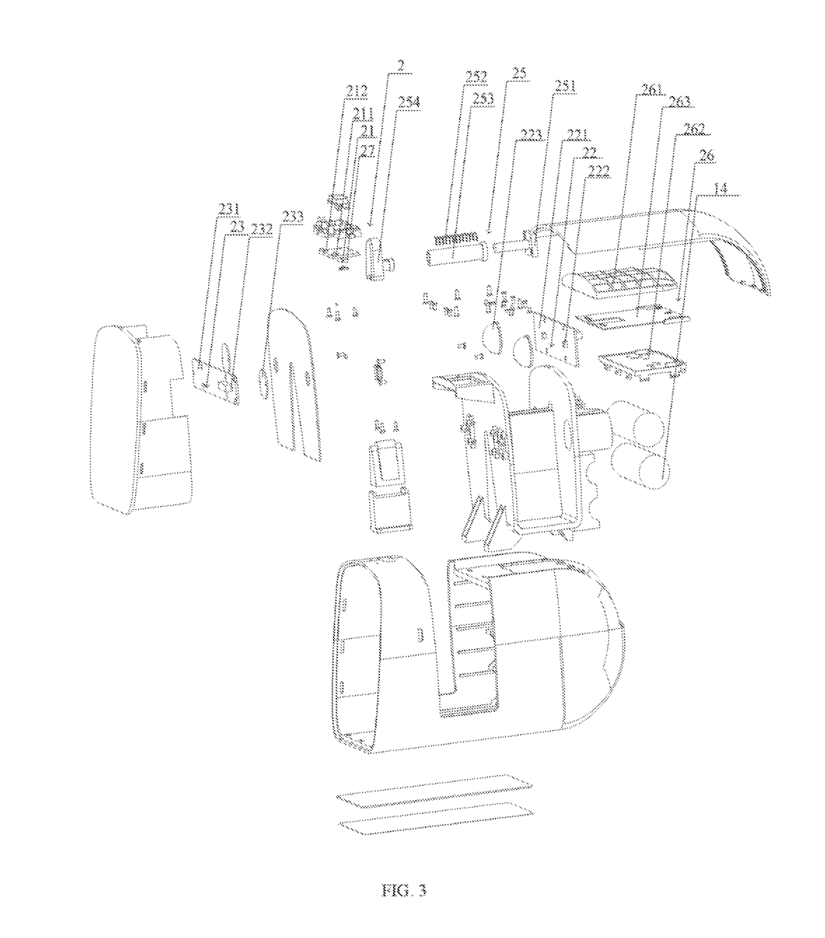

The present disclosure relates to a lens detection device, as shown in FIGS. 1 to 3. The detection device includes a housing 1 and a detection module 2 configured within the housing 1. The detection module 2 includes a control module 21, at least one light emitting module 22, and a photosensitive module 23 cooperating with the light emitting module 22. The control module 21 controls the light emitting module 22 and the photosensitive module 23 for conducting a detection process to a lens disposed between the light emitting module 22 and the photosensitive module 23.

The detection module 2 may conduct an effective detection process via cooperation between the light emitting module 22 and the photosensitive module 23 photosensitive module 23. As such, the lens detection may become much more convenient, the detection time may be reduced, and the lens detection device may be adopted widely thereby. The lens is disposed between the light emitting module 22 and the photosensitive module 23, and the light emitting module 22 emits light beams to the photosensitive module 23 via the lens. The photosensitive module 23 collects wavelength of the light beams, intensity of the light beams, and refractive index of the lens. The control module 21 processes data rapidly and displays a detection result of the lens. Such that, the detection result may be displayed intuitively. It is only necessary to place the lens to be detected to a designated position of the detection device, and the detection device may obtain the detection result quickly and easily, so that the lens detection may become much simpler and more convenient.

The detection device of the present disclosure has a small size, and is much more portable and useable than conventional large scale detection equipment. Due to the small size, the manufacturing costs may be reduced, and the market competitiveness of the detection device may be further improved.

The detection module 2 is configured within the housing 1. The influence of ambient light on the light emitting module 22 and the photosensitive module 23 may be avoided, so that the detection device may be further improved, and the lens detection may become more accurate. The housing 1 can effectively protect the detection module 2, so as to improve the durability of the detection device, and the service life of the detection device may be further extended.

Specifically, the housing 1 includes a middle frame 11. The light emitting module 22 and the photosensitive module 23 are configured on the middle frame 11. The middle frame 11 may enable the light emitting module 22 and the photosensitive module 23 to be fixed effectively.

As such, the cooperation of the light emitting module 22 and the photosensitive module 23 and the accuracy of the lens detection may be further improved. The middle frame 11 includes a first side wall 111 and a second side wall 112. The light emitting module 22 is configured on the first side wall 111 and the photosensitive module 23 is configured on the second side wall 112, wherein the first side wall 111 is parallel to the second side wall 112. A linear propagation of the light beams is facilitated by providing the first side wall 111 and the second side wall 112 in parallel to effectively avoid light loss of the light emitting module 22. Such that, the light beams transmitted from the light emitting module 22 may effectively be received by the photosensitive module 23, so as to improve the accuracy of the detection device, to improve the accuracy of the lens detection, and to ensure the lens quality. To place the lens that meets the requirements on the glasses frame may ensure the safety of glasses users, and the lens of the glasses may be more reliable while using. The first side wall 111 and the second side wall 112 are spaced apart to facilitate the placement of the lens, and to fix the lens effectively, so as to improve the lens detection.

The light emitting module 22 includes a first circuit board 221 and a second circuit board 231. A least one detection lamp 222 is arranged on the first circuit board 221 and at least one sensor 232 is arranged on the second board 231. The sensor 232 is configured to detect the light beams emitted from the detection lamp 222. The first circuit board 221 and the second circuit board 231 may be controlled effectively via the control module 21. A lens detection process may be performed via the following process. The detection lamp 222 emits the detection beams, the lens is placed between the first side wall 111 and the second side wall 112, and the detection beams is filtered via the lens and is transmitted to the photosensitive module 23. Wherein the detection lamp 222 may be light emitting diodes (LEDs), blue lights, or ultraviolet (UV) lights, and the detection lamp 222 may be set in groups according to the kinds of the lights so as to control the detection lamp 222. The blue light is shortwave in the spectrum, thus the blue light may penetrate cornea and lens to reach the retina, causing damages on the retina, and increasing the prevalence of macular disease. For example, the LED white light and UV light are set into a group. The LED white light may be turned on while detecting an anti-bluelight effect of the lens. The sensor 232 may detect the blue light effectively by detecting the light beams passing through the lens.

The light emitting module 22 includes a first filter 223 cooperating with the detection lamp 222, and the photosensitive module 23 includes a second filter 233 cooperating with the sensor 232. Non-detected light beams may be filtered by the first filter 223 and the second filter 233 so as to reduce interference and to further improve the accuracy of the lens detection. The first filter 223 may be in arc-shaped. The arc-shaped filter 223 may diverge the detected light beams and enlarge detected area, so as to detect the lens comprehensively and to simplify the operation of the detection device.

The first side wall 111 includes at least one first through hole 224 engageble with the detection lamp 222 thereon, and the second side wall 112 includes at least one second through hole 234 engageble with the sensor 232. The first filter 223 is configured above the first through hole 224 and the second filter 233 is configured on the second through hole 234. The first filter 223 and the second filter 233 may effectively fixed via the first through hole 224 and the second through hole 234, so that the first filter 223 and the second filter 233 may be mounted easily. The first through hole 224 and the second through hole 234 may also protect the first filter 223 and the second filter 233, so as to further improve the durability of the first filter 223 and the second filter 233, to prevent surfaces of the first filter 223 and the second filter 233 from being scratched, and to further improve the lens detection. The first filter 223 and the second filter 233 may further protect the detection device and the sensor 232 to ensure the performance of the detection.

The middle frame 11 includes a support module 24 configured between the first side wall 111 and the second side wall 112. The support module 24 includes a support block 241 and a support fixing block 242, wherein the support fixing block 242 is fixed on the middle framell, and the support block 241 is configured on the support fixing block 242. The support module 24 may facilitate the placement of a glasses frame. A position of a nose pad of the glasses frame may be stuck on the support block 241, so as to effectively support and fix the glasses, to avoid the influence of a shaking of the glasses on the detection result, and to facilitate the detection of the lens of the glasses. The support fixing block 242 is fixed to the middle frame 11, and the support fixing block 242 may effectively support the support block 241. The support block 241 is made of rubber material having certain flexibility, so as to fit different shape of nose-pads, to fix the glasses effectively, and to further improve the accuracy of the lens detection. According to different shape of the nose-pads, the different support blocks may be adopted to effectively fix the detected glasses.

In one example, the first side wall includes two first through holes 224 and the second side includes two second through holes 234. The two first through holes 224 and the two second through holes 234 are symmetrically arranged with respect to the support module 24. In one example, the light emitting module includes two the detection lamps 222 respectively correspond to the two first through holes 224. The first through holes 224 and the second through holes 234 may facilitate the detection of the lens. The lens is not necessary to be removed from the glass while detecting, as such, the accuracy of the lens detection may be improved and the operation of the detection process may become more convenient. The two lenses of the glasses may simultaneously be detected, and a differentiated detection process may be conducted on the two lenses of the glasses. For example, it may be possible to detect the anti-blue effect of one lens while detecting the anti-ultraviolet effect of the other lens.

A clamping module 25 is configured on the middle frame 11. One end of the clamping module 25 is fixed to the first side wall 111, and a telescopic structure is arranged on the other end of the clamping module 25. The clamping module 25 may cooperate with the support module 24, so as to fix the glasses more stable and to improve the efficiency of the lens detection. The operation of the detection process may become more convenient and may further improve the accuracy of the lens detection. The telescopic structure may fit with and fix to a variety shape of the glasses. According to the frame of the glasses the telescopic structure may adaptability adjust to fix the frame tightly and to limit the glasses, as such, the lens detection may be improved.

The middle frame 11 further includes a protection sheet configured to limit and to protect the lens.

The clamping module 25 includes a fixing baffle 251 configured on the first side wall 111, and the telescopic structure. The fixing baffle 251 is fixed to the first side wall 111 in order to fix a first baffle more stable and to facilitate the operation of the telescopic structure. The telescopic structure includes a compression spring 252, a guide tube 253, and an indenter 254. A fixing pillar is configured on the fixing baffle 251. The compression spring 252 is mounted on the fixing pillar, and the guide tube 253 is mounted on the compression spring 252. One end of the indenter 254 is arranged within the guide tube 253 and corresponds to the compression spring 252. The guide tube 253 is configured to guide the indenter 254 to compress along a direction of the guide tube 253. Such that, the glasses may be fixed tightly and may be limited, so as to improve the lens detection. The compression spring 252 may provide resilience on the indenter 254 to fix the glasses more stable. The fixing pillar and the guide tube 253 may limit the compression spring 252.

The housing 1 includes a top shell 12 configured with a sliding rail module 26 configured to control a slide motion of the top shell 12. The sliding rail module 26 may effectively control the slide motion of the top shell 12 to slide. When the top shell 12 is slide to fold, the top shell 12 may cover the middle frame 11, such that, ashes may not fall into the middle fame 11 and may not reach to the first filter 223 and the second filter 233, so that the accuracy of the detection device may be improved. The top shell 12 may be slide to unfold while using. The lens to be detected is placed between the first side wall 111 and the second side wall 112 while detecting. The top shell 12 may be slide to fold during the detection process, so as to avoid the interference of the ambient light and to further improve the accuracy of the lens detection. The sliding rail module 26 may facilitate the detection device, may reduce operational difficulties of the detection device, and may simplify the operation of the detection device.

The housing 1 includes a bottom shell 13. The slide rail module 26 includes a first fixing plate 261 fixed to the top shell 12, and a second fixing plate 262 fixed to the bottom shell 13. A sliding rail plate 263 is configured between the first fixing plate 261 and the second fixing plate 262. The first fixing plate 261 is fixed to the top shell 12. The first fixing plate 261 has reinforcing ribs cross staggered, so that the rigidity of the upper case 12 may be effectively strengthened. The second fixing plate 262 is fixed to the bottom shell 13 to limit the slide rail module 26 and to ensure the slide rail module 26 can be operated stably. The sliding rail plate 263 may effectively drive the upper case 12 to slide, such that the fold operation and the unfold operation of the top shell 12 may be operated rapidly, so as to improve the efficiency of the lens detection.

A power supply 14 is configured within the housing 1, and the control module 21 includes a third circuit board 211 being connected to the power supply 14. At least one control key 213 and at least one indicator lamp 212 are configured on the third circuit board 3. The control key 213 may control the power supply 14 and third circuit board 211 to switch on or switch off, so as to effectively control the operation of the detection device. The third circuit board 211 and the first circuit board 221 connect to the second circuit board 231. The third circuit board 211 may effectively control the first circuit board 221 and the second circuit board 231. For example, the number of the indicator lamp 212 is three, and is configured with red color, green color, and yellow color respectively. The indicator lamp 212 may effectively reduce the costs and further improve the market competitiveness of the detection device. The sensor 232 transmits detected data to the control module 21 when the control key 213 is pressed. The indicator lamp 212 turns into red color upon the control module 21 has finished the computation of the data. When a portable device is connected to the detection device, the application (APP) of the portable device may display an initial value. When the glasses is placed on the detection device, the sensor 232 detects the light beams passing through and transmits the data to the control module 21. The three different indicator lamps 212 respectively display colors upon the control module 21 finished the computation of the data. When the indicator lamp 212 turns into red color, it represents no protection, i.e., the lens is not capable of anti-UV and anti-bluelight. When the indicator lamp 212 turns into green color, it represents well protection, i.e., the lens is capable of anti-UV and anti-bluelight. When the indicator lamp 212 turns into yellow color, it represents middle protection, i.e., the lens is capable of anti-UV and anti-bluelight partially. When the portable device is connected to the detection device, the APP of the portable device may display the data directly. The power supply 14 may adopts a rechargeable power supply for the convenience of the detection device to use while moving, and may be used as an emergency power supply in emergency.

An universal Serial Bus (USB) port is configured on the second circuit board 231, and is configured to connect the power supply 14.

The control module 21 further includes a wireless module 27. The wireless module 27 may be a Bluetooth module. The wireless module 27 may transmits the detected data and the detected result to the portable device. The portable device may control the detection device via the APP, such that the operation of the detection device may become much easier. Pressing the control key 213 while operating, the sensor 232 transmits the detected data to the control module 21 via an inter-integrated circuit (I2C), and the data is transmitted to the portable device via the wireless module 27. The APP within the portable device may display the initial value. When the glasses is placed on the detection device, the sensor 232 detects the light beams passing through and transmits the data to the control module 21. The control module 21 transmits the detection result to the portable device via the wireless module 27 upon the control module 21 finished the computation of the data. The APP within the portable device may display the value directly. Bluetooth is a standard wireless technique using an UHF radio wave in the ISM band in a range from 2.4 to 2.485 GHz and is configured to exchange data in short distance between a fixed device, a mobile device, and a personal area network. Bluetooth may connect multiple devices to overcome data synchronization problems. In one example, the wireless module 27 may adopt a WIFI module, a 2G module, a 3G module, a 4G module, and a 5G module.

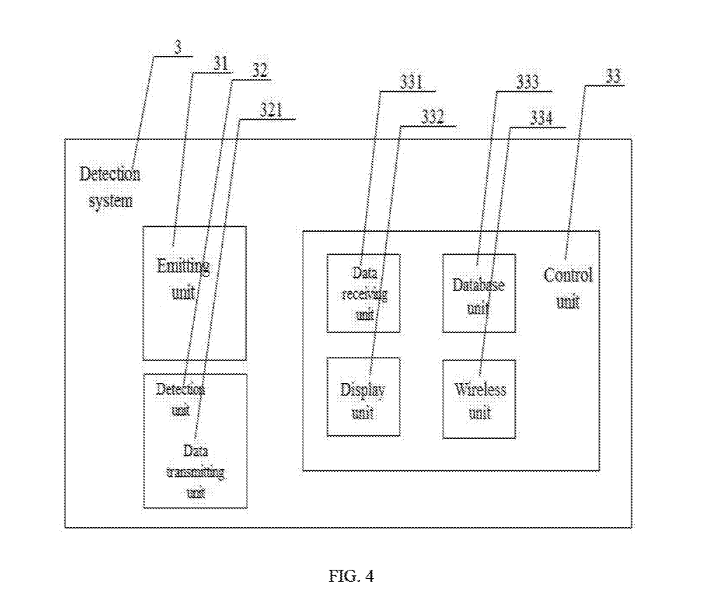

In another aspect, as shown in FIG. 4, the present disclosure further relates to a lens detection system 3. The lens detection system 3 may include an emitting unit, a detection unit, and a control unit.

The emitting unit is configured to emit detection light beams.

Specifically, the emitting unit may be a light detection emitter, such as a UV emitter.

The detection unit configured to receive the detection light beams.

Specifically, the detection unit 32 includes a data transmit unit 321, and the control unit 33 includes a data receiving unit 331. The data transmit unit 321 transmits the data detected by the detection unit to the data receiving unit 331, and the control unit 33 processes the data transmitted from the data transmit unit 321. The control unit 33 may effectively control the emitting unit 31 and the detection unit 32. The detection unit 32 may transmit the data detected by the detection unit to the control unit 33 via the I2C. As such the control unit 33 may process the data.

The control unit configured to receive and to process data of the emitting unit and the detection unit.

The control unit 33 includes a display unit 332 configured to display the detection result. The detection result is displayed via the display unit. In one example, the display unit 332 may be the indicator lamp 212 configured to display different colors in accordance with different results. For example, red color represents no protection; green color represents well protection; yellow color represents middle protection. The display unit 332 may be a display screen configured to display the detected result and the detected data.

The control unit 33 further includes a database unit 333 configured to store and transmit the data. The database unit 333 may store the data to be received or the data to be processed and may facilitate a quick indexing, a quick querying and a quick storage for the control unit 33, so as to increase the processing speed of the control unit 33.

The control unit 33 further includes a wireless unit 334. The wireless unit 334 is configured to transmit the detected data and the detected result to the portable device. The portable device may control the detection device via the APP, such that the operation of the detection device may become much easier. Pressing the control key 213 while operating, the sensor 232 transmits the detected data to the control module 21 via the I2C, and the data is transmitted to the portable device via the wireless unit 334. The APP within the portable device may display the initial value. When the glasses is placed on the detection device, the sensor 232 detects the light beams passing through and transmits the data to the control module 21. The control module 21 transmits the detection result to the portable device via the wireless module 27 upon the control module 21 finished the computation of the data. The APP within the portable device may display the value directly.

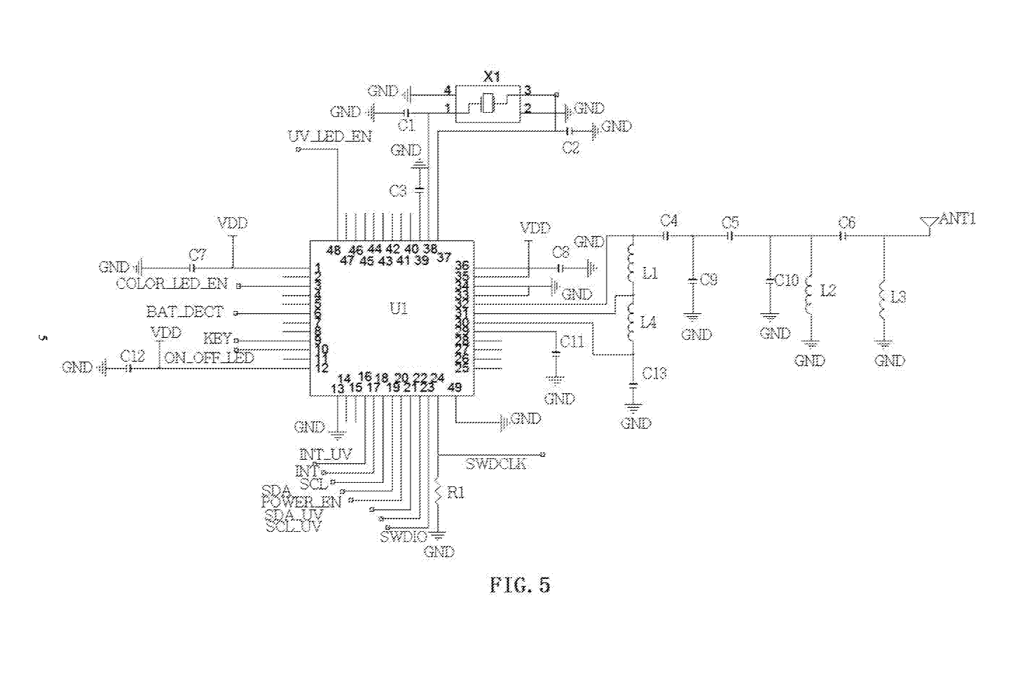

As shown in FIG. 5, the control unit 33 is mainly responsible for an analog to digital (AD) sample detection, data signal access, and logical control. A fifth pin and an eighth pin connect the detection unit 32 to detect an integrated value. A seventh pin connects a resistor R3 and the LED indicator lamp 212 to control a state of the LED 212. A thirty-first pin and a thirty-second pin connect to the wireless unit 334.

The wireless unit 334 is mainly responsible for matching an onboard antenna. Such that the portable device, such as mobile phone and tablet, may transmit the data in a long distance and in a reliable way.

In one example, the detection unit 32 may be an UV sensor 232. The UV sensor adopts silicon products manufactured by silicon on insulator (SOI) technique. The SOI technique is introducing a layer of buried oxide between a top layer silicon layer and a backing substrate. The SOI technique has attributes comparing bulk silicon such as the SOI may integrate circuit components of media isolation, and may completely eliminate parasitic latch effect of bulk silicon CMOS circuits. The integrate circuit has attributes such as small parasitic capacitance, high integration density, fast speed, simple process, and small short-channel effect. The integrate circuit particularly suitable for low-voltage circuit and low-power circuit. As such, the present disclosure may accurately detect and rapidly response to a present ultra violet index (UVI), and may provide a great protection to prevent users from a variety of skin discomfort symptoms caused by exposure to ultraviolet light in the sun. When ultraviolet rays are irradiate on the sensor 232, the top layer silicon formed by an UV photodiode in the sensor 232 is irradiated with a certain intensity of ultraviolet radiation to produce a corresponding small current. The small current passes through an operational (OP) amplifier within the sensor 232 to obtain a corresponding output voltage and transmit to a microcontroller unit (MCU) for sampling.

When ultraviolet ray is irradiated to the detection unit 32. The top layer silicon formed by the UV photodiode in the detection unit 32 is irradiated with the certain intensity of ultraviolet radiation to produce a corresponding current. The current passes through the OP amplifier within the sensor 232 to obtain the corresponding output voltage and to transmit the output voltage to the MCU for sampling. The control unit 33 is mainly responsible for the AD sample detection, data signal access, and logical control. The wireless unit 334 is mainly responsible for matching the onboard antenna. In one example, the Bluetooth is adopted for matching, such that the detection system and the portable device may transmit the data in a long distance and in a reliable way. The UV sensor adopts silicon products manufactured by the SOI technique. The SOI technique is introducing the layer of buried oxide between the top layer silicon and the backing substrate.

The fifth pin and the eighth pin connect the detection unit 32. The detection unit 32 transforms the ultraviolet intensity signals into an analog voltage, and outputs the analog voltage. The detection unit 32 converses the analog voltage according a relation of the output voltage, Analog-to-Digital Converter (ADC) voltage, and the UVI, and displays in the value form on a terminal device.

The detection unit 32 includes a chip U2. An out pin of the chip U2 connects the fifth pin of the control unit 33. An EN pin of the chip connects to the eighth pin of the control unit 33. A TR pin of the chip U2 connects to a seventeenth capacitance C17 and grounded. A GND pin of the chip U2 is grounded. A VDD pin of the chip U2 connects to volt current condenser (VCC). A fifteenth capacitance C15 is connected between the GND pin of the chip U2 and the VDD pin of the chip U2.

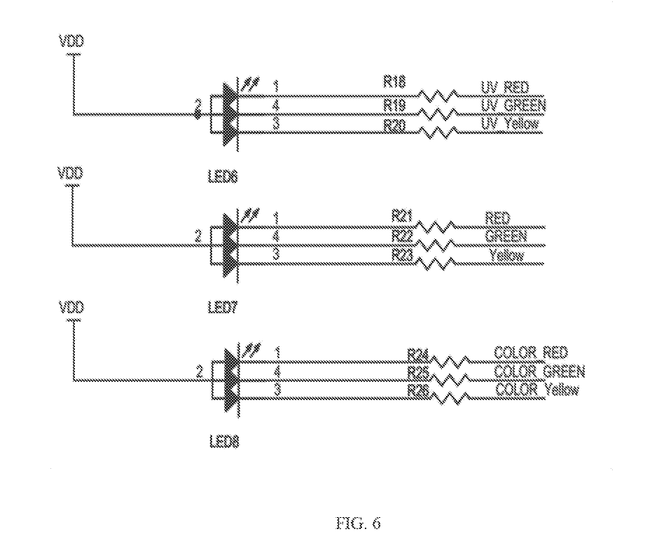

As shown in FIG. 6, a seventh pin of the control unit 33 connects the resistance R3 and LED indicator 212 to control the state of the LED 212. The three LED indicator lamps 212 display colors upon the control module 21 has finished the computation of the data. For example, red color represents no protection; green color represents well protection; yellow color represents middle protection. When the portable device is connected to the detection device, the app of the portable device may display the value directly.

A thirty-first pin and a thirty second pin of the control unit 33 connect the wireless unit 334. The wireless unit 334 includes a first circuit L1, a second circuit L2, a third circuit L3, a fourth circuit L4, a third capacitance C3, a fourth capacitance C4, a fifth capacitance C5, a sixth capacitance C6, a fourteenth capacitance C14, a sixteenth capacitance C16, and an antenna. The antenna, the sixteenth capacitance C16, the fourteenth capacitance C14, the fifth capacitance C5, the first circuit L1, the second circuit L2, the third capacitance C3 connect in series and connect to the ground. A lead between the first circuit L1 and the fifth capacitance C5 connects to the thirty second pin of the control unit 33. A lead between the first circuit L1 and the second circuit L2 connects to the thirty first pin of the control unit 33. A lead between the second circuit L2 and the third capacitance C3 connects to the thirty pin of the control unit 33. The fourth capacitance C4 is connected between the fifth capacitance C5 and the fourteenth capacitance C14 and is grounded. The sixth capacitance C6 and the third circuit L3 are connected between the fourteenth capacitance C14 and the sixteenth capacitance C16 in parallel. The sixth capacitance C6 and the third circuit L3 are grounded. The fourth circuit L4 is connected between the sixteenth capacitance C16 and the antenna, and the fourth circuit L4 is grounded.

The control unit 33 includes the chip with 48 pins. The first pin connects to the VCC, and is grounded via a twelfth capacitance C12. A ninth pin connects to a switch. The twelfth capacitance connects to the VCC, and is grounded via an eleventh capacitance C11. A thirteen pin is grounded. A twenty-fourth pin is grounded via the first resistance R1. A twenty-third pin connects to a D point. The twenty-fourth pin connects to C point. A G point is grounded, wherein the D point, the C point, and the G point are MCU (Micro Control Unit) programming points. A twenty ninth pin is grounded via a tenth capacitance C10. A thirty-third pin and thirty-fourth pin are grounded. A thirty-fifth and a thirty-sixth pin connect to the VCC. The thirty-fifth pin and thirty-sixth pin are grounded via a ninth capacitance C9. A thirty-seventh pin is grounded via the first capacitance C1. A thirty-eighth pin is grounded via the second capacitance C2. A crystal oscillator Y1 is connected between a thirty-seventh pin and a thirty-ninth pin. A thirty-ninth pin is grounded via an eighth capacitance C8.

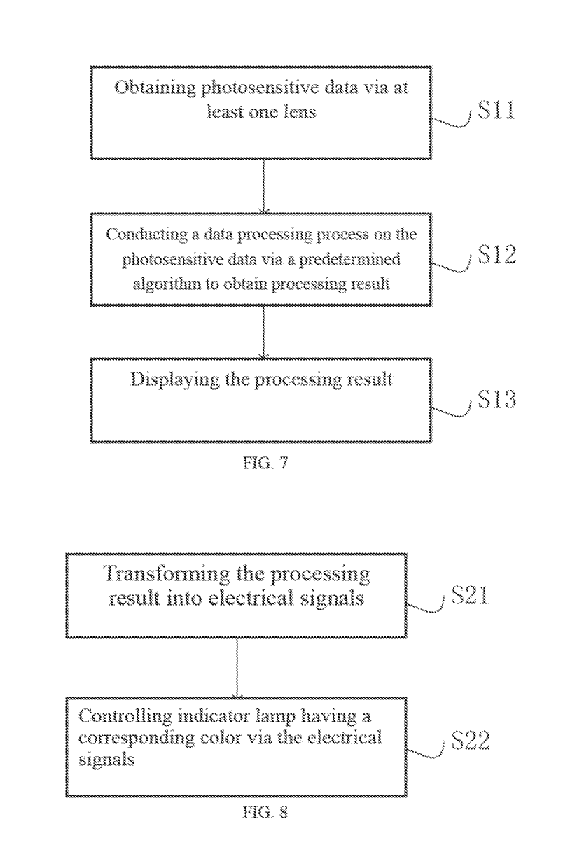

In another aspect, as shown in FIG. 7, the present disclosure further relates to a lens detection method, including:

In S11: obtaining photosensitive data via at least one lens.

In S12: conducting a data processing process on the photosensitive data via a predetermined algorithm to obtain processing result.

In S13: displaying the processing result.

Wherein the photosensitive data includes at least one light wavelength, light intensity, and lens refractive index.

The sensor 232 detects the photosensitive data passing through the glasses, and conducts the data processing process on the photosensitive data via the predetermined algorithm, wherein the predetermined algorithm may be a process comparing with a standard data, so as to effectively determine a protection level of the lens meets a standard requirement. The result may be displayed by the display screen or the indicator lamp 212. As such, the lens detection may be much more convenient and may reduce detection time. The lens detection may be adopted widely thereby. The light emitting module 22 emits light beams to the photosensitive module 23 via the lens. The photosensitive module 23 collects wavelength of the light beams, intensity of the light beams, and refractive index of the lens. The control module 21 processes data rapidly and displays a detection result of the lens, such that, the detection result may be displayed intuitively. It is only necessary to place the lens to be detected to a designated position of the detection device, and the detection device may obtain the detection result quickly and easily, so that the lens detection may become much more convenient and simple.

As shown in FIG. 8, the displaying process includes:

In S21: transforming the processing result into electrical signals.

In S22: controlling at least one indicator lamp having a corresponding color via the electrical signals.

The sensor 232 transmits detected data to the control module 21. The control module 21 transforms the processing result into electrical signals. upon the control module 21 has finished the computation of the data. The three indicator lamp 212 may display colors respectively. For example, red color represents no protection, green color represents well protection, and yellow color represents middle protection.

The above description is only the embodiments in the present disclosure. The claim is not limited to the description thereby. The equivalent structure or changing of the process of the content of the description and the figures, or to implement to other technical field directly or indirectly should be included in the claim.

What is claimed is:

1. A lens detection device, comprising:
a housing; and
a detection module configured within the housing;
wherein the detection module comprises a control module, at least one light emitting module, and a photosensitive module cooperating with the light emitting module; the control module controls the light emitting module and the photosensitive module for conducting a detection process to a lens disposed between the light emitting module and the photosensitive module while detecting.

2. The lens detection device according to claim 1, wherein the housing comprises a middle frame, wherein the light emitting module and the photosensitive module are configured on the middle frame; the middle frame comprises a first side wall and a second side wall arranged parallel to the first side wall, wherein the light emitting module is configured on the first side wall, and the photosensitive module is configured on the second side wall.

3. The lens detection device according to claim 2, wherein the light emitting module comprises a first circuit board and a second circuit board; at least one detection lamp is arranged on the first circuit board and at least one sensor is arranged on the second board; the sensor is configured to detect light beams emitted from the detection lamp.

4. The lens detection device according to claim 3, wherein the light emitting module further comprises a first filter cooperating with the detection lamp and a second filter cooperating with the sensor; the first filter is arc-shaped.

5. The lens detection device according to claim 4, wherein the first side wall comprises at least one first through hole cooperating with the detection lamp thereon; the second side wall comprises at least one second through hole cooperating with the sensor; the first filter is configured above the first through hole and the second filter is configured on the second through hole.

6. The lens detection device according to claim 5, wherein a support module is arranged on the middle frame, and the support module is configured between the first side wall and the second side wall; the support module comprises a support block and a support fixing block, wherein the support fixing block is fixed on the middle frame, and the support block is configured on the support fixing block.

7. The lens detection device according to claim 6, wherein the first side wall comprises two first through holes and the second side comprises two second through holes; the two first through holes and the two second through holes are symmetrically arranged with respect to the support module; the light emitting module comprises two detection lamps respectively correspond to the two first through holes.

8. The lens detection device according to claim 2, wherein a clamping module is configured on the middle frame; one end of the clamping module is fixed to the first side wall, and a telescopic structure is arranged on the other end of the clamping module.

9. The lens detection device according to claim 8, wherein the clamping module comprises a fixing baffle configured on the first side wall; the telescopic structure comprises a compression spring, a guide tube, and an indenter; a fixing pillar is configured on the fixing baffle; the compression spring is mounted on the fixing pillar, and the guide tube is mounted on the compression spring; one end of the indenter is arranged within the guide tube and corresponds to the compression spring.

10. The lens detection device according to claim 1, wherein the housing comprises a top shell configured with a sliding rail module, and the sliding rail module controls a slide motion of the top shell to slide.

11. The lens detection device according to claim 10, wherein the housing comprises a bottom shell; the slide rail module comprises a first fixing plate fixed to the top shell and a second fixing plate fixed to the bottom shell; a sliding rail plate is configured between the first fixing plate and the second fixing plate.

12. The lens detection device according to claim 1, wherein a power supply is configured within the housing, and the control module comprises a third circuit board being connected to the power supply; at least one control key and at least one indicator lamp are configured on the third circuit board.

13. The lens detection device according to claim 1, wherein the control module further comprises a wireless module.

14. A lens detection system, comprising:
an emitting unit configured to emit detection light beams;
a detection unit configured to receive the detection light beams;
a control unit configured to receive and to process data of the emitting unit and the detection unit.

15. The lens detection system according to claim 14, wherein the detection unit comprises a data transmit unit, and the control unit comprises a data receiving unit; the data transmit unit transmits the data detected by the detection unit to the data receiving unit, and the control unit processes the data transmitted from the data transmit unit.

16. The lens detection system according to claim 14, wherein the control unit comprises a display unit configured to display a detection result,.

17. The lens detection system according to claim 14, wherein the control unit further comprises a database unit configured to store and transmit the data.

18. The lens detection system according to claim 14, wherein the control unit further comprises a wireless unit configured to connect with a portable terminal.

19. A lens detection method, comprising:
obtaining photosensitive data via at least one lens;
conducting a data processing process on the photosensitive data via a predetermined algorithm to obtain processing result;
displaying the processing result;
wherein the photosensitive data comprise at least one light wavelength, light intensity, and lens refractive index.

20. The lens detection method according to claim 19, wherein the displaying process comprises:
transforming the processing result into electrical signals;
controlling at least one indicator lamp having a corresponding color via the electrical signals.
